(19) United States
(12) Patent Application Publication
(10) Pub. No.: US 2016/0170417 A1
(43) Pub. Date: Jun. 16, 2016

(54) Wireless Surface Controlled Active Inflow Control Valve System

(71) Applicants: Kai Sun, JR., Missouri City, TX (US); Namhyo Kim, Houston, TX (US); Luis Phillipe Costa Ferreira Tosi, Houston, TX (US); Krystian K. Maskos, Houston, TX (US); Jeffery Lawrence Hall, South Pasadena, CA (US); Stewart Sherrit, La Crescenta, CA (US); Harish M. Manohara, Glendora, CA (US); Mohammad Mehdi Mojarradi, La Canada, CA (US); Eric Dean Archer, La Canada, CA (US); Allen Roy Sirota, Northridge, CA (US); Erik J. Brandon, Pasadena, CA (US)

(72) Inventors: Kai Sun, JR., Missouri City, TX (US); Namhyo Kim, Houston, TX (US); Luis Phillipe Costa Ferreira Tosi, Houston, TX (US); Krystian K. Maskos, Houston, TX (US); Jeffery Lawrence Hall, South Pasadena, CA (US); Stewart Sherrit, La Crescenta, CA (US); Harish M. Manohara, Glendora, CA (US); Mohammad Mehdi Mojarradi, La Canada, CA (US); Eric Dean Archer, La Canada, CA (US); Allen Roy Sirota, Northridge, CA (US); Erik J. Brandon, Pasadena, CA (US)

(73) Assignees: CALIFORNIA INSTITUTE OF TECHNOLOGY, Pasadena, CA (US); CHEVRON U.S.A. INC., San Ramon, CA (US)

(21) Appl. No.: 14/569,152

(22) Filed: Dec. 12, 2014

(51) Int. Cl. G05D 7/06; H04W 4/00

(52) U.S. Cl. CPC G05D 7/0676; H04W 4/008

(57) ABSTRACT

A wirelessly controlled active inflow control valve system. The valve system includes at least one downhole zonal production control unit. The at least one zonal production control unit includes a valve configured to control an inflow of fluid, at least one sensor configured to sense at least one parameter, and a central downhole control and data acquisition unit communicatively coupled to the valve and the at least one sensor. The central downhole control and data acquisition unit sends an actuation signal to the valve and receives at least one data output from the at least one sensor. The central downhole control and data acquisition unit transmits the at least one data output to a surface control and data acquisition unit via a wireless communication protocol and receives a control command from the surface downhole control and data acquisition unit via the wireless communication protocol.

### ACKNOWLEDGMENT OF GOVERNMENT SUPPORT

The invention described herein was made in the performance of work under a NASA contract, and is subject to the provisions of Public Law 96-517 (35 USC 202) in which the Contractor has elected to retain title.

### TECHNICAL FIELD

The present application relates to inflow control valve systems for oil and gas recovery applications. Specifically, the present application relates to an inflow control valve system capable of communicating wirelessly with a surface control center.

### BACKGROUND

Vertical, slant or horizontal production or injection wells with multiple formation zones often exhibit varied formation pressure and varied flow rates from/into each formation zones. This is due to the differences in each zone's formation pressure and permeability. This effect can negatively impact the recovery efficiency of the well. For example, in production wells, the formation zone with higher pressure and flow rate may produce faster causing it to become depleted faster or earlier. Water breakthrough brings negative effect for other zones recovery; or, for injection wells, the injection fluids will select the most permeable zones to flow into, causing hydrocarbon from other zones to remain unrecovered.

Horizontal production or injection wells inside a homogeneous formation will still exhibit varied flow rates along the length of the well. This is typically due to frictional pressure losses, also known as the heel-toe effect, in which the flow rate near the heel of the well is greater than the flow rate at the toe end of the well. This effect can negatively impact the recovery efficiency of the well. For example, in production wells, the high flow rate heel section may experience earlier water breakthrough. This may prevent hydrocarbon in toe section from being produced.

Downhole inflow control tools have been used to regulate flow rates at various portions of the well in order to optimize the flow/injection rates across the producing/injection length of the well. Downhole inflow control tools are typically placed on the production tubing and act as a valve, regulating the flow of fluids from the well into the production tubing. The typical downhole inflow control tools include the active type, wherein a downhole inflow control valve can be remotely controlled through control lines (hydraulic or electric) from the surface. The valve can adjust the size of the opening to regulate one zone's flow rate or close the opening to shut one zone's production. Thus, the active type of inflow control tool is capable of responding to changes in the natural flow rate of the reservoir. Another typical downhole inflow control tool includes the passive type without the function of the remote control, which includes a restricted-flow path having a fixed geometry or size. Once the device is deployed downhole, the flow-restriction size cannot be changed. Thus, the passive inflow control device is not capable of responding to changes in the natural flow rate of the reservoir.

### SUMMARY

In general, in one aspect, the disclosure relates to a wirelessly controlled active inflow control valve system. The valve system includes at least one downhole zonal production control unit. The at least one zonal production control unit includes at least one valve configured to control an inflow of fluid, at least one sensor configured to sense at least one parameter, and a central downhole control and data acquisition unit communicatively coupled to the valve and the at least one sensor. The central downhole control and data acquisition unit sends an actuation signal to the valve and receives at least one data output from the at least one sensor. The central downhole control and data acquisition unit transmits the at least one data output to a surface control and data acquisition unit via a wireless communication protocol and receives a control command from the surface downhole control and data acquisition unit via the wireless communication protocol.

In another aspect, the disclosure can generally relate to a wirelessly controlled active inflow control valve system. The valve system includes a first downhole zonal production control unit and a second downhole zonal production control unit. The first downhole zonal production control unit includes a first valve configured to control the flow of a fluid from a reservoir into the valve system. The first downhole zonal production control unit also includes a first local downhole control and data acquisition unit coupled to the valve and configured to control actuation of the first valve. The first downhole zonal production control unit also includes at least one first sensor communicatively coupled to the first local controller. The at least one sensor is configured to sense at least one parameter relevant to the first downhole zonal production control unit, wherein the first local downhole control and data acquisition unit receives a first data output from the at least one first sensor. The second downhole zonal production control unit includes a second valve configured to control the flow of a fluid from a reservoir into the valve system. The second downhole zonal production control unit also includes a second local downhole control and data acquisition unit coupled to the valve and configured to control actuation of the second valve. The second downhole zonal production control unit also includes at least one second sensor communicatively coupled to the second local downhole control and data acquisition unit and configured to sense at least one parameter relevant to the second downhole zonal production control unit. The second local downhole control and data acquisition unit receives a second data output from the at least one second sensor. The first local downhole control and data acquisition unit and the second local downhole control and data acquisition unit wirelessly transmit the first data output and the second data output, respectively, to a surface control and data acquisition unit. The first local downhole control and data acquisition unit and the second local downhole control and data acquisition unit wirelessly receive a first control command and a second control command, respectively, from the surface control and data acquisition unit.

In another aspect, the disclosure can generally relate to a method of controlling an active inflow control valve system. The method includes receiving a wireless control command from a surface control and data acquisition unit, and sending a control signal to one or more inflow control valves, the control signal implementing the control command. The method also includes actuating the one or more inflow control valves according to the control signal, and sensing a parameter related to the one or more inflow control valves or downhole conditions corresponding to the one or more inflow control valves. The method also includes receiving an output data from the sensed one or more parameters, and sending the output data wirelessly to the surface control and data acquisition unit.

These and other aspects, objects, features, and embodiments will be apparent from the following description and the appended claims.

### BRIEF DESCRIPTION OF THE DRAWINGS

The drawings illustrate only example embodiments of the present disclosure, and are therefore not to be considered limiting of its scope, as the disclosures herein may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements. In one or more embodiments, one or more of the features shown in each of the figures may be omitted, added, repeated, and/or substituted. Accordingly, embodiments of the present disclosure should not be limited to the specific arrangements of components shown in these figures.

FIG. 1 illustrates a schematic diagram of a well site in which a wirelessly controlled active inflow control valve system has been deployed downhole, in accordance with example embodiments of the present disclosure;

FIG. 2a illustrates an example embodiment of a wirelessly controlled active inflow control valve system having local downhole control and data acquisition units, in accordance with example embodiments of the present disclosure;

FIG. 2b is a diagram illustrating a first example of a wiring scheme of the wirelessly controlled active inflow control valve system of FIG. 2a, in accordance with example embodiments of the present disclosure;

FIG. 2c is a diagram illustrating a second example of a wiring scheme of the wirelessly controlled active inflow control valve system 200 of FIG. 2a, in accordance with example embodiments of the present disclosure;

FIG. 3 illustrates a block diagram of the wirelessly controlled active inflow control valve system of FIG. 2a, in accordance with example embodiments of the present disclosure;

FIG. 4a illustrates an example embodiment of a wirelessly controlled active inflow control valve system having a central downhole control and data acquisition unit, in accordance with example embodiments of the present disclosure;

FIG. 4b is a diagram illustrating a first example of a wiring scheme of the wirelessly controlled active inflow control valve system of FIG. 4a, in accordance with example embodiments of the present disclosure;

FIG. 4c is a diagram illustrating a second example of a wiring scheme of the wirelessly controlled active inflow control valve system of FIG. 4a, in accordance with example embodiments of the present disclosure;

FIG. 5 illustrates a block diagram of the wirelessly controlled active inflow control valve system of FIG. 4a, in accordance with example embodiments of the present disclosure;

FIG. 6 illustrates a block diagram of a another embodiment of a wirelessly controlled active inflow control valve system, in accordance with example embodiments of the present disclosure;

FIG. 7 illustrates a first communication scheme of a wirelessly controlled active inflow control valve system, in accordance with example embodiments of the present disclosure;

FIG. 8 illustrates a second communication scheme of a wirelessly controlled active inflow control valve system, in accordance with example embodiments of the present disclosure; and

FIG. 9 illustrates a third communication scheme of a wirelessly controlled active inflow control valve system, in accordance with example embodiments of the present disclosure.

### DETAILED DESCRIPTION OF EXAMPLE EMBODIMENTS

Example embodiments directed to a wirelessly controlled active inflow control valve system will now be described in detail with reference to the accompanying figures. Like, but not necessarily the same or identical, elements in the various figures are denoted by like reference numerals for consistency. In the following detailed description of the example embodiments, numerous specific details are set forth in order to provide a more thorough understanding of the disclosure herein. However, it will be apparent to one of ordinary skill in the art that the example embodiments disclosed herein may be practiced without these specific details. In other instances, well-known features have not been described in detail to avoid unnecessarily complicating the description. The example embodiments illustrated herein include certain components that may be replaced by alternate or equivalent components in other example embodiments as will be apparent to one or ordinary skill in the art.

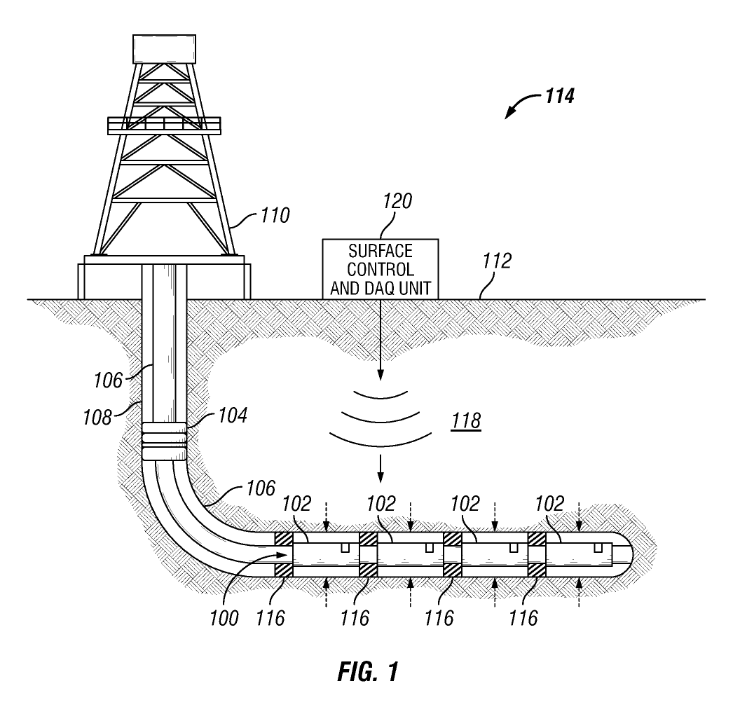

Referring now to the drawings, FIG. 1 illustrates a schematic diagram of a well site 114 in which a wireless controlled active inflow control valve system has been deployed downhole, in accordance with example embodiments of the present disclosure. In certain example embodiments, and as illustrated, the wireless controlled active inflow control valve system 100 (hereinafter “valve system”) is deployed in a horizontal wellbore 108. In certain example embodiments, the well 108 is a vertical or slant or s-type with multiple production zones. The wellbore 108 is formed in a subterranean formation 118 and coupled to a platform 110 on a surface 112 of the formation 118. The formation 118 can include one or more of a number of formation types, including but not limited to shale, limestone, sandstone, clay, sand, and salt. The surface 112 may be ground level for an on-shore application or the sea floor for an off-shore application. In certain embodiments, a subterranean formation 118 can also include one or more reservoirs in which one or more resources (e.g., oil, gas, water, steam) are located. In certain example embodiments, the wellbore 108 is cased with cement or other casing material, which is perforated to allow fluids to flow from the formation 118 into the well 108.

A production tubing 106 is disposed downhole within the well 108. Fluids are recovered and brought to the platform 110 through the production tubing. In certain example embodiments, a production packer 104 is coupled to the production tubing 106. In certain example embodiments, the valve system 100 includes one or more zonal production control units (ZPCU) 102 coupled to the production tubing 106 at various linear portions. In certain example embodiments, the zonal production control unit 102 control the flow of fluid from the well 108 or formation 118 into the production tubing 106. In certain example embodiments, a packer 116 is placed between each zonal production control unit 102, thereby isolating each respective portion of the well 108. Placement of zonal production control units 102 and the packers 116 separates the well 108 into one or more well zones. Each of the zonal production control unit 102 is configured to independently control the flow rate or shut-in of fluids from the reservoir into the production tubing at its respective zone.

In certain example embodiments, there is a surface control center located aboveground, which allows operators 122 to monitor and control the valve system 100. The surface control center includes a surface control and data acquisition (DAQ) unit 120. In certain example embodiments, the surface control and data acquisition unit 120 is configured to communicate wirelessly with the valve system 100. This includes receiving data from the valve system 100 regarding downhole conditions and system conditions. The surface control and data acquisition unit 120 is also configured to send control signals to the valve system 100 regarding operation of the zonal production control units 102. In certain example embodiments, the surface control and data acquisition unit 120 receives control inputs from an operator 122, and transmits corresponding control signals to the valve system 100. In certain example embodiments, the surface control and data acquisition unit 120 includes a wireless communications system and/or a wireless transducer or antenna (not shown).

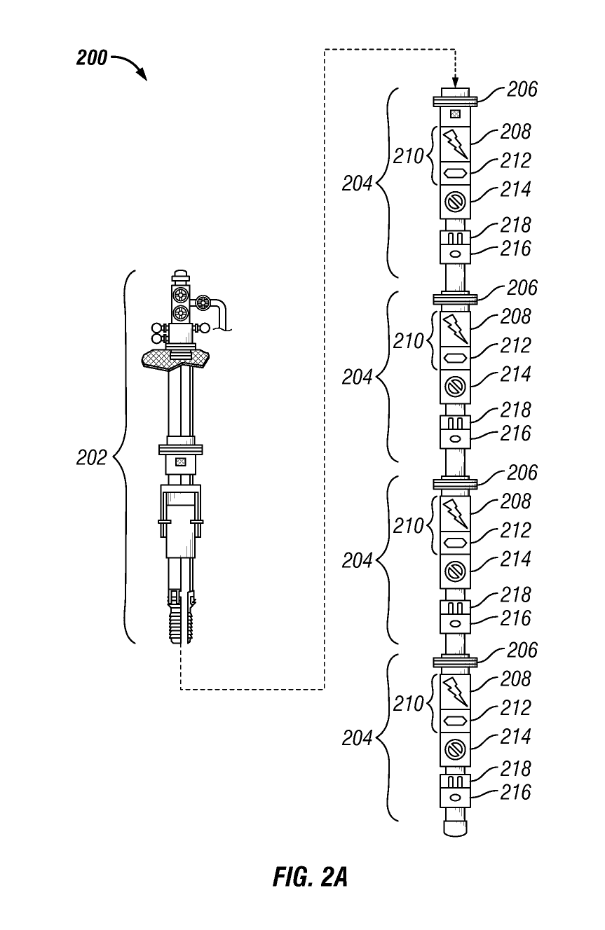

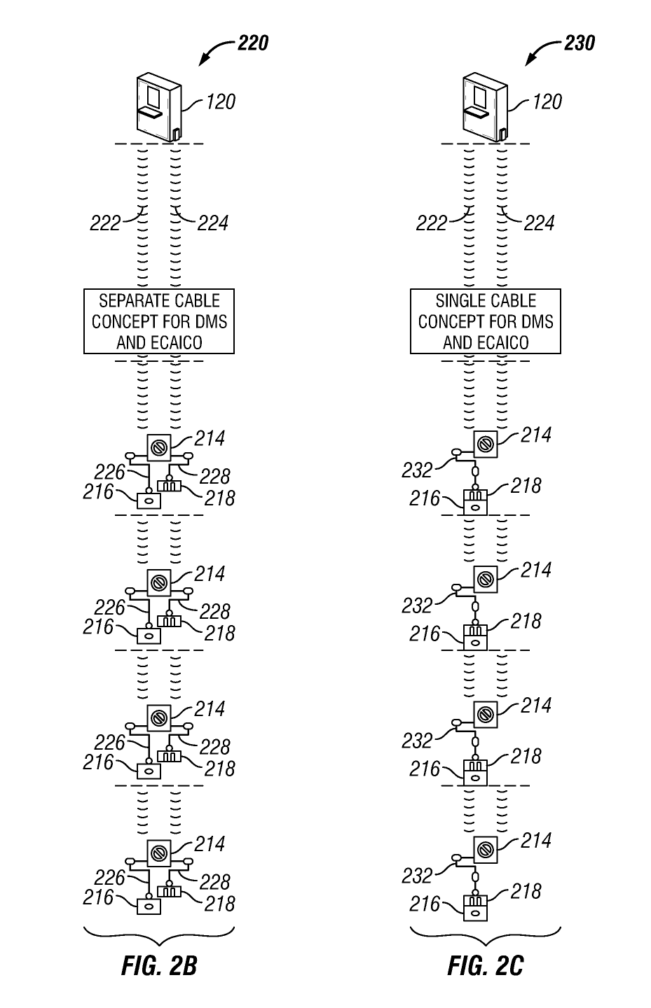

FIG. 2a illustrates a first example embodiment of the valve system 100, denoted therein by reference number 200, implemented on a production tubing string, in accordance with example embodiments of the present disclosure. FIG. 3 illustrates a block diagram of the valve system 200. In certain example embodiments, the valve system 200 is implemented below an upper completion 202 portion of the production tubing. Referring to FIGS. 2a and 3, the valve system 200 includes one or more zonal production control units 204. Each of the zonal production control units 204 correspond to respective zones in the wellbore 108, each of which is isolated by one or more packers 206. In certain example embodiments, a packer 206 is placed between each of the zonal production control units 204.

In this example embodiment, each zonal production control unit 204 includes a local downhole control and data acquisition unit 214. Furthermore, in certain example embodiments, each zonal production control unit 204 also includes a power unit 210. The power unit 210 may include a downhole power generation unit 208 and/or a power storage unit 212, such as a well life service battery. Each zonal production control unit 204 also includes one or more sensing or monitoring devices 218 and one or more inflow control valves 216.

In certain example embodiments, the inflow control valves 216 control the flow of fluids from the respective portion of the formation 118 or wellbore 108 into the production tubing 106. For example, the inflow control valves 216 can be opened to increase flow, choked back to decrease flow, or closed to stop flow. In certain example embodiments, each inflow control valve 216 is controlled by the respective local downhole control and data acquisition unit 214. In certain example embodiments, the local downhole control and data acquisition unit 214 controls the respective inflow control valve 216 based on a signal or command received from the surface control and data acquisition unit 120.

In certain example embodiments, the one or more sensing or monitoring devices 218 collect data regarding one or more parameters related to the respective zonal production control unit 204 and the respective well zone's formation and production conditions. For example the one or more sensing or monitoring devices 218 may include a flow meter, a pressure sensor, temperature sensor, acoustic sensor, phase detection sensor, and the like. Each of the one or more sensing or monitoring devices 218 is configured to generate data regarding at least one parameter such as flow rate, pressure, temperature, sound, and phase composition of fluids. In certain example embodiments, the one or more sensing or monitoring devices 218 outputs the generated data to the local downhole control and data acquisition unit 214 and the data is then communicated to the surface control and data acquisition unit 120. In certain example embodiments, the surface control and data acquisition unit 120 includes, stored in memory, a pre-programmed control protocol which determines how to control each of the inflow control valve 216 based on the received data. In certain example embodiments, the local downhole control and data acquisition unit 214 includes, stored in memory, a pre-programmed control protocol which determines how to control each of the inflow control valve 216 based on the received monitoring data, such as decreasing an opening size or emergency shut-in of the inflow control valve 216.

In certain example embodiments, the power unit 210 supplies power to the inflow control valves 216 and the sensing or monitoring devices 218. In certain example embodiments, the power unit 210 includes a downhole power generation device 208. In certain example embodiments, the downhole power generation device 208 generates energy by harvesting energy from the flow of production fluid within the well 108, and converts the mechanical energy into electrical energy. For example, the downhole power generation device 208 may utilize, but is not limited to, piezoelectric power generation techniques or turbine power generation techniques. In certain other example embodiments, the downhole power generation device 208 generates energy by a nuclear power generator within the device 208 or by harvesting energy from geothermal energy within the well 108, and converts the mechanical energy into electrical energy. In certain example embodiments, electrical energy generated by the downhole power generation device 208 is stored in the power storage device 212, which then supplied power to the inflow control valves 216 and the sensing or monitoring devices 218.

In certain example embodiments, the local downhole control and data acquisition unit 214 is electrically coupled to the respective sensing or monitoring devices 218 and the respective inflow control valve 216. The local downhole control and data acquisition unit 214 receives outputs from the sensing or monitoring devices 218 indicative of the measured conditions, which may be in the form of a voltage or other signal. The local downhole control and data acquisition unit 214 then processes the output. In certain example embodiments, the local downhole control and data acquisition unit 214 includes a wireless communication transceiver, and the output data is converted into a data form compatible for transmitting via the wireless communication transceiver. The wireless communication transceiver then transmits the processed data to the surface control and data acquisition unit 120. In certain example embodiments, the local downhole control and data acquisition unit 214 receives a control signal from the surface control and data acquisition unit 120 for actuating the corresponding inflow control valve 216. In certain example embodiments, the surface control and data acquisition unit 120 receives the control signal via the wireless communication transceiver. The local downhole control and data acquisition unit 214 then processes the control signal, and sends the appropriate actuation signal to the inflow control valve 216 to carry out the intended action.

The wireless communication between the surface control and data acquisition unit 120 and the local down downhole control and data acquisition units 214 can be various types of wireless telemetry and wireless communication protocols, including mud telemetry, wireless local area network, Bluetooth, transmission control protocol/internet protocol, acoustic telemetry, and the like.

In one example embodiment, the valve system 200 may be controlled from the surface control and data acquisition unit 120 in order to normalize the flow rate across each of the one or more zonal production control unit 204. For example, the surface control and data acquisition unit 120 receives data regarding the flow conditions at each of the one or more zonal production control unit 204, and determines that one of the zonal production control units 204 is seeing a flow rate at its well zone that is significantly higher than that seen by the other zonal production control units 204 in the valve system. The surface control and data acquisition unit 120 may send control signals to that zonal production control unit 204 to choke back the respective valve 216, thereby decreasing the flow rate to better match the flow rate at the other well zones. Such a condition can be seen by an operator 122 monitoring the system or autonomously detected by the surface control and data acquisition unit 120.

FIG. 2b is a diagram illustrating a first example of a wiring scheme 220 of the valve system 200, in accordance with example embodiments of the present disclosure. In certain example embodiment, the surface control and data acquisition unit 120 sends a wireless communication signal 222 to each of the local downhole control and data acquisition units 214. In this example embodiment, the local downhole control and data acquisition units 214 are coupled to the inflow control valve 216 via a first cable 226 and coupled to the sensing or monitoring devices 218 via a second cable 228. FIG. 2c is a diagram illustrating a second example of a wiring scheme 230 of the valve system 200, in accordance with example embodiments of the present disclosure. In this embodiment, the local downhole control and data acquisition unit 214 communicates with the inflow control valve 216 and the sensing and monitoring devices 218 via a single cable 232.

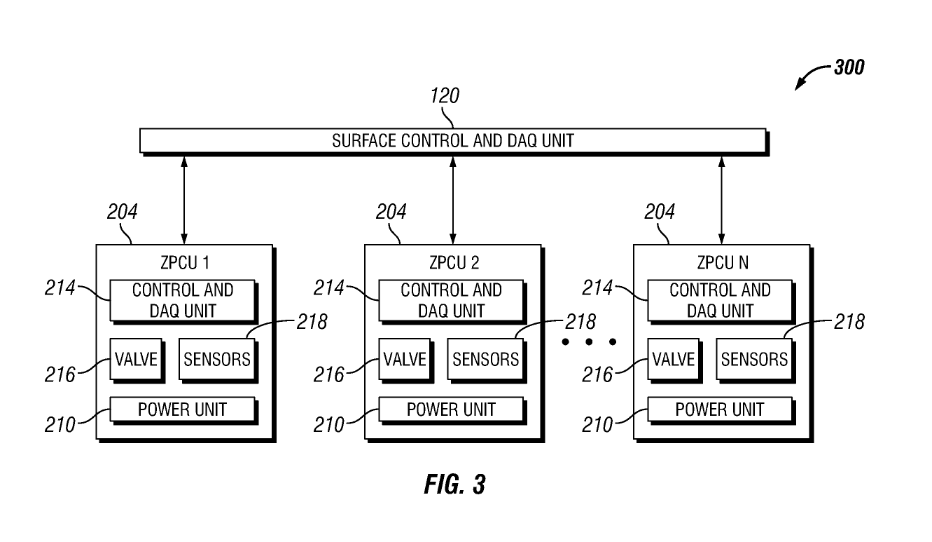

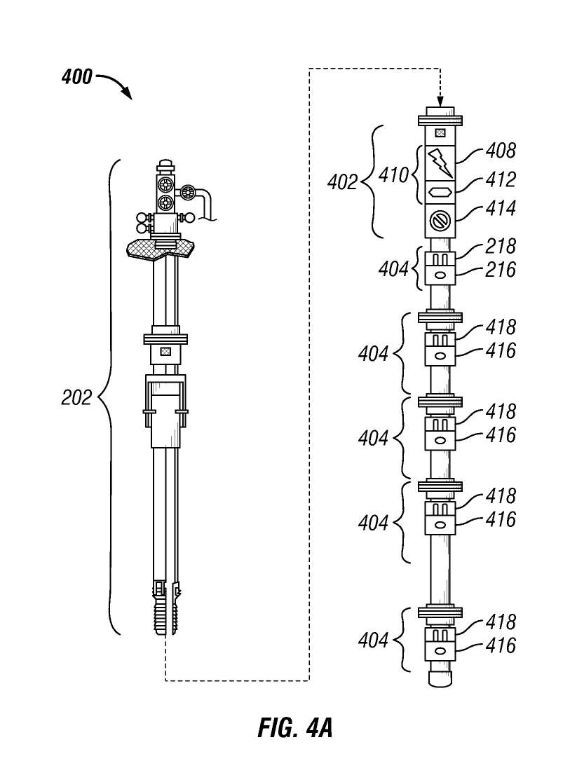

FIG. 4a illustrates a second example embodiment of the valve system 100, denoted therein by reference number 400, implemented on a production tubing string, in accordance with example embodiments of the present disclosure. FIG. 5 illustrates a block diagram of the valve system 400. In certain example embodiments, the valve system 400 is installed below an upper completion 202 portion of the production tubing. Referring to FIGS. 4a and 5, the valve system 400 includes one or more zonal production control units 404 and a central controller 402. Each of the zonal production control unit 404 correspond to respective zones in the wellbore 108, each of which is isolated by one or more packers 206. In this example embodiment, each zonal production control unit 404 includes one or more sensing or monitoring devices 418 and one or more inflow control valves 416, which are similar to the sensing or monitoring devices 218 and inflow control valves 216 described above with respect to FIG. 2a. The central controller 402 includes a central downhole control and data acquisition unit 414. In certain example embodiments, the central controller 402 also includes a power unit 410. In certain such embodiments, the power unit 410 includes a downhole power generation unit 408 and/or a power storage unit 412, such as a well life service battery.

In such example embodiments, each of the inflow control valves 416 and sensing or monitoring devices 418 are communicatively and electrically coupled to the central control 402. The central controller 402 can communicate with the inflow control valves 416 and sensing or monitoring devices 418 via a single cable 432, multiple cables 422 and 428, or wirelessly. In certain example embodiments, each of the sensing or monitoring devices 418 measures one or more parameters related to the respective zonal production control unit 404 or the respective well zone. In certain example embodiments, the sensing or monitoring devices 418 output the measured data to the central controller 402, where the data is processed and transmitted to the surface control and data acquisition unit 120.

In certain example embodiments, the inflow control valves 416 are controlled by the central controller 402. The inflow control valves 416 control the flow of fluids from the respective portion of the formation 118 or well 108 into the production tubing 106. For example, the inflow control valves 416 can be opened to increase flow, choked back to decrease flow, or closed to stop flow. In certain example embodiments, the central control unit 402 sends individual control signals to each of the inflow control valves 416 for uniquely controlling the individual inflow control valve 416. In certain example embodiments, the central controller 402 receives a command from the surface control and data acquisition unit 120 and controls the inflow control valves 416 accordingly. In certain example embodiments, these commands can be generated and/or executed autonomously.

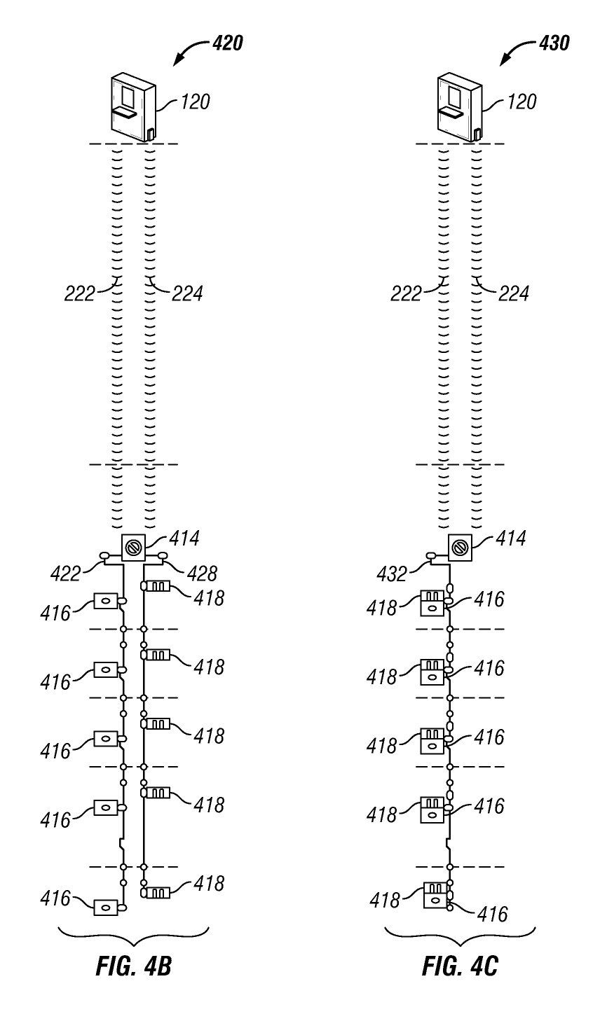

In certain example embodiments, the inflow control valves 416 and the sensing or monitoring devices 418 are powered by the power unit 410 of the central controller 402. In alternate embodiments, power units can be distributed. For example, FIG. 6 illustrates a block diagram of a valve system 600 in which each zonal production control unit 604 includes a local power unit 610, in accordance with example embodiments of the present disclosure. In certain example embodiments, the valve system 600 includes one or more zonal production control units 604 and a central controller 602. In certain example embodiments, the zonal production control unit 604 includes one or more inflow control valves 616, one or more sensing or monitoring devices 618, and a power unit 610. Thus, in such example embodiments, each zonal production control unit 604 is powered by its own power source. The central controller 602 includes a central downhole control and data acquisition unit 614. The central downhole control and data acquisition unit 614 controls receives data from the sensing or monitoring devices 618 and transmit the data to the surface control and data acquisition unit 120. The central downhole control and data acquisition unit 614 also receives control commands from the surface control and data acquisition unit 120 and actuates the inflow control devices 604 accordingly.

FIG. 4b is a diagram illustrating a first example of a wiring scheme 420 of the valve system 400, in accordance with example embodiments of the present disclosure. In certain example embodiment, the surface control and data acquisition unit 120 sends a wireless communication signal 222 to the central downhole control and data acquisition unit 414. In this example embodiment, the central downhole control and data acquisition unit 414 is coupled to the inflow control valves 416 via a first cable 422 and coupled to the sensing or monitoring devices 418 via a second cable 428. In certain example embodiment, the surface control and data acquisition unit 120 receives a wireless communication signal 224 from the central downhole control and data acquisition unit 414. FIG. 4c is a diagram illustrating a second example of a wiring scheme 430 of the valve system 400, in accordance with example embodiments of the present disclosure. In this embodiment, the central downhole control and data acquisition unit 414 communicates with the inflow control valves 416 and the sensing and monitoring devices 418 via a single cable 432.

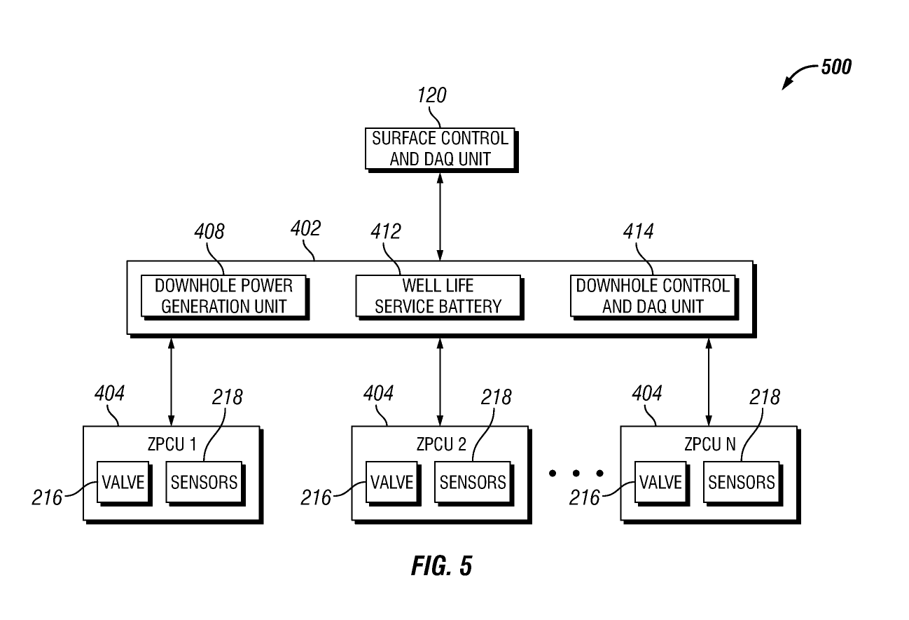

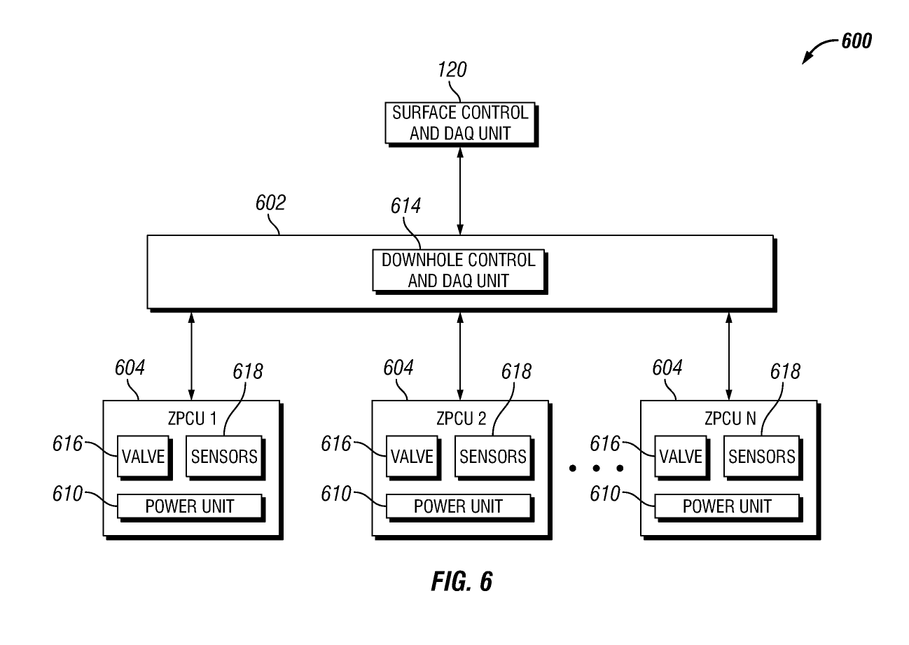

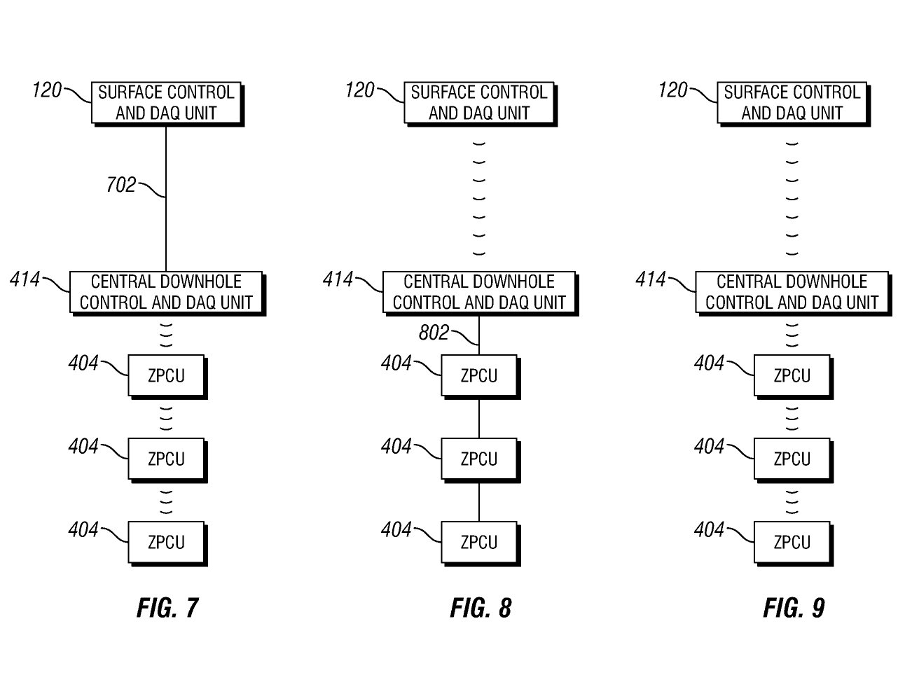

The valve system 400 can have any combination of communication types. For example, FIG. 7 illustrates a communication scheme in which the surface control and data acquisition unit 120 communicates with the central downhole control and data acquisition unit 414 via a wireline 702, and in which the central downhole control and data acquisition unit 414 then communicates with each of the zonal production control units 404 via wireless communication. FIG. 8 illustrates a communication scheme in which the surface control and data acquisition unit 120 communicates with the central downhole control and data acquisition unit 414 via wireless communication, and in which the central downhole control and data acquisition unit 414 then communicates with each of the zonal production control units 404 via a wireline 802. FIG. 9 illustrates a communication scheme in which the surface control and data acquisition unit 120 communicates with the central downhole control and data acquisition unit 414 via wireless communication, and in which the central downhole control and data acquisition unit 414 then communicates with each of the zonal production control units 404 via wireless communication.

The embodiments described herein can be used with or without modifications for the injection wells wherein injection fluids such as water, polymers, gas, steam or other fluid media flow through the production tubing 106 to the well 108 or the formation 118 to enhance the productivity of the reservoir.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A wirelessly controlled active inflow control valve system, comprising:
at least one zonal production control unit comprising:
a valve configured to control an inflow of fluid; and
at least one sensor configured to sense at least one parameter, and
a central downhole control and data acquisition unit communicatively coupled to the valve and the at least one sensor,
wherein the central downhole control and data acquisition unit sends an actuation signal to the valve and receives at least one data output from the at least one sensor; and
wherein the central downhole control and data acquisition unit transmits the at least one data output to a surface control and data acquisition unit via a wireless communication protocol and receives a control command from the surface downhole control and data acquisition unit via the wireless communication protocol.

2. The wirelessly controlled active inflow control valve system of claim 1, comprising:
a central power unit electrically coupled to the at least one zonal production control unit and the central downhole control and data acquisition unit, wherein the central power unit provides power to the valve and the at least sensor and the central downhole control and data acquisition unit.

3. The wirelessly controlled active inflow control valve system of claim 2, wherein the central power unit comprises a downhole power generation system and a power storage device.

4. The wirelessly controlled active inflow control valve system of claim 1, wherein at least one zonal production control unit further comprises a power unit, wherein the power unit supplies power to the valve and the at least one sensor.

5. The wirelessly controlled active inflow control valve system of claim 1, wherein the at least one sensor includes one or more of a flow meter and a pressure sensor.

6. The wirelessly controlled active inflow control valve system of claim 1, wherein the valve controls a flow of fluid from a reservoir into a production and injection tubing to which the active inflow control valve system is attached.

7. The wirelessly controlled active inflow control valve system of claim 1, further comprising:
a first zonal production control unit comprising:
a first valve configured to control or shut-in an inflow of fluid from a first portion of a reservoir; and
a first sensor configured to sense at least one parameter related to the first portion of the reservoir, and
a second zonal production control unit comprising:
a second valve configured to control or shut-in an inflow of fluid from a second portion of the reservoir; and
a second sensor configured to sense at least one parameter related to the second portion of the reservoir,
wherein the central downhole control and data acquisition unit is communicatively coupled to the first zonal production control unit and the second zonal production control unit.

8. The wirelessly controlled active inflow control valve system of claim 1, wherein the wireless communication protocol is selected from a group comprising: mud pulse telemetry, wireless local area network, Bluetooth technology, transmission control protocol/internal protocol, and acoustic protocol.

9. An autonomous active inflow control valve system, comprising:
a first downhole zonal production control unit comprising:
a first valve configured to control the flow of a fluid from a reservoir into the valve system;
a first local downhole control and data acquisition unit coupled to the valve and configured to control actuation of the first valve; and
at least one first sensor communicatively coupled to the first local controller and configured to sense at least one parameter relevant to the first downhole zonal production control unit, wherein the first local downhole control and data acquisition unit receives a first data output from the at least one first sensor; and
a second downhole zonal production control unit comprising:
a second valve configured to control the flow of a fluid from a reservoir into the valve system;
a second local downhole control and data acquisition unit coupled to the valve and configured to control actuation of the second valve; and
at least one second sensor communicatively coupled to the second local downhole control and data acquisition unit and configured to sense at least one parameter relevant to the second downhole zonal production control unit, wherein the second local downhole control and data acquisition unit receives a second data output from the at least one second sensor,
wherein the first local downhole control and data acquisition unit and the second local downhole control and data acquisition unit wirelessly transmit the first data output and the second data output, respectively, to a surface control and data acquisition unit, and
wherein the first local downhole control and data acquisition unit and the second local downhole control and data acquisition unit wirelessly receive a first control command and a second control command, respectively, from the surface control and data acquisition unit.

10. The autonomous active inflow control valve system of claim 9, wherein the first downhole inflow control device comprises a first power unit and the second downhole zonal production control unit comprises a second power unit.

11. The autonomous active inflow control valve system of claim 10, wherein the first power unit and the second power unit each comprises a downhole power generation device and a power storage device.

12. The autonomous active inflow control valve system of claim 9, further comprising a central power unit.

13. The autonomous active inflow control valve system of claim 12, wherein the central power unit comprises a downhole power generation device and a power storage device.

14. The autonomous active inflow control valve system of claim 9, wherein the first local downhole control and data acquisition unit and the second local downhole control and data acquisition unit communicate with the surface control and data acquisition unit via a wireless communication protocol selected from a group comprising: mud pulse telemetry, wireless local area network, Bluetooth technology, and transmission control protocol/internal protocol.

15. The autonomous active inflow control valve system of claim 9, wherein an opening size of the first valve changes according to a first control command received by the first local downhole control and data acquisition unit from the surface control and data acquisition unit.

16. A method of controlling an active inflow control valve system, comprising:
receiving a wireless control command from a surface control and data acquisition unit;
sending a control signal to one or more inflow control valves, the control signal implementing the control command;
actuating the one or more inflow control valves according to the control signal;
sensing a parameter related to the one or more inflow control valves or downhole conditions corresponding to the one or more inflow control valves;
receiving an output data from the sensed one or more parameters; and
sending the output data wirelessly to the surface control and data acquisition unit.

17. The method of controlling an active inflow control valve system of claim 16, further comprising:
decreasing an opening size of the inflow control valve when a measured inflow rate of the inflow control valve or another measured parameter is above a certain threshold.

18. The method of controlling an active inflow control valve system of claim 16, further comprising:
receiving a first wireless control command from the surface control and data acquisition unit and a second wireless control command from the surface control and data acquisition unit;
sending a first control signal to a first inflow control valve carrying out the first wireless control command and sending a second control signal to a second inflow control valve carrying out the second wireless control command;
sensing a first parameter related to the first inflow control valve and sensing a second parameter related to the second inflow control valve; and
sending a first data output of the first sensed parameter to the surface control and data acquisition unit and sending a second data output of the second sensed parameter to the surface control and data acquisition unit.

19. The method of controlling an active inflow control valve system of claim 16, further comprising:
normalizing inflow rates of a first inflow control valve and a second inflow control valve by actuating the first and second inflow control valves accordingly.

20. The method of controlling an active inflow control valve system of claim 1, further comprising:
communicating with the surface control and data acquisition unit via a wireless communication protocol selected from a group comprising: mud pulse telemetry, wireless local area network, Bluetooth technology, and transmission control protocol/internal protocol.
